(19) United States
(12) Patent Application Publication
(10) Pub. No.: US 2026/0229934 A1
(43) Pub. Date: Aug. 6, 2026

(54) STATOR CORE OF ELECTRIC MOTOR, STATOR, ELECTRIC MOTOR, AND METHOD FOR MANUFACTURING STATOR CORE

(71) Applicant: Fanuc Corporation, Minamitsuru-gun, Yamanashi (JP)

(72) Inventor: Yasuhito MUKAI, Minamitsuru-gun, Yamanashi (JP)

(73) Assignee: Fanuc Corporation, Minamitsuru-gun, Yamanashi (JP)

(21) Appl. No.: 19/149,761

(22) PCT Filed: Feb. 1, 2023
(86) PCT No.: PCT/JP2023/003238

§ 371 Date: Jul. 21, 2025

(51) Int. Cl. H02K 1/20; H02K 15/0273

(52) U.S. Cl. CPC H02K 1/20; H02K 15/0273

(57) ABSTRACT

A stator core of an electric motor includes multiple core plates laminated in an axial direction of the stator core, wherein each of the core plates has a polygonal outer shape and a refrigerant hole in a closed area demarcating a flow path through which a refrigerant flows. The multiple core plates comprise a first core plate and a second core plate laminated to the first core plate, wherein the second core plate has a shape in which the first core plate is inverted about a symmetrical axis of the polygon, or the first core plate is rotated about a central axis thereof by a central angle of the polygon. The refrigerant hole of the first core plate extends in a circumferential direction of the stator core, and a portion thereof communicates with the refrigerant hole of the second core plate in the axial direction.

### CROSS REFERENCE TO RELATED APPLICATIONS

This is the U.S. National Phase application of PCT/JP2023/003238, filed Feb. 1, 2023, the disclosure of this application being incorporated herein by reference in its entirety for all purposes.

### FIELD OF THE INVENTION

The present disclosure relates to a stator core of an electric motor, a stator, an electric motor, and a method of manufacturing a stator core.

### BACKGROUND OF THE INVENTION

A water-cooling stator is known (e.g., Patent Literature 1 and Patent Literature 2).

### PATENT LITERATURE

PTL 1: JP 2006-33916 A

PTL 2: JP 4-145859 A

### SUMMARY OF THE INVENTION

### Technical Problem

In the related art, for a stator with a cooling function, there is a need to reduce manufacturing costs while maintaining high cooling efficiency.

In an aspect of the present disclosure, a stator core of an electric motor includes a plurality of core plates stacked in an axial direction of the stator core, each core plate having an outer shape of polygon, and including a refrigerant hole of a closed area which defines a channel through which the refrigerant flows. The plurality of core plates includes a first core plate, and a second core plate stacked on the first core plate, and having a shape obtained by inverting the first core plate around a symmetry axis of the polygon or rotating the first core plate around a central axis of the first core plate by a center angle of the polygon. The refrigerant hole of the first core plate extends in a circumferential direction of the stator core, and a part of the refrigerant hole of the first core plate fluidly communicates with the refrigerant hole of the second core plate in the axial direction.

### BRIEF DESCRIPTION OF DRAWINGS

FIG. 1 is a side view of an electric motor according to an embodiment and illustrates a part of a cross-section.

FIG. 2 is a perspective view of a stator illustrated in FIG. 1.

FIG. 3 is a front view of a core plate making up a stator core illustrated in FIG. 2.

FIG. 4 is a diagram for describing a stacking arrangement of core plates of a first group to an eighth group illustrated in FIG. 2.

FIG. 5 illustrates a channel formed inside the stator core illustrated in FIG. 2.

FIG. 6 is a perspective view of a front bracket illustrated in FIG. 2.

FIG. 7 is a perspective view of a rear bracket illustrated in FIG. 2.

FIG. 8 is a perspective view of a stator according to another embodiment.

FIG. 9 is a diagram illustrating a state where the rear bracket is omitted in the stator illustrated in FIG. 8.

FIG. 10 is a front view of a core plate making up a stator core illustrated in FIG. 9.

FIG. 11 is a diagram for describing a stacking arrangement of core plates of a first group and a second group illustrated in FIG. 9.

FIG. 12 illustrates a channel formed inside the stator illustrated in FIG. 8.

FIG. 13 is a perspective view of a front bracket illustrated in FIG. 8.

FIG. 14 is a diagram for describing fluid communication between a channel of a stator core and a refrigerant recess of a front bracket illustrated in FIG. 12.

FIG. 15 is a diagram for describing fluid communication between the stator core channel and the refrigerant recess of the front bracket illustrated in FIG. 12.

FIG. 16 is a front view of a core plate according to another embodiment.

FIG. 17 is a diagram for describing a stacking arrangement of the core plate illustrated in FIG. 16.

### DETAILED DESCRIPTION OF EMBODIMENTS OF THE INVENTION

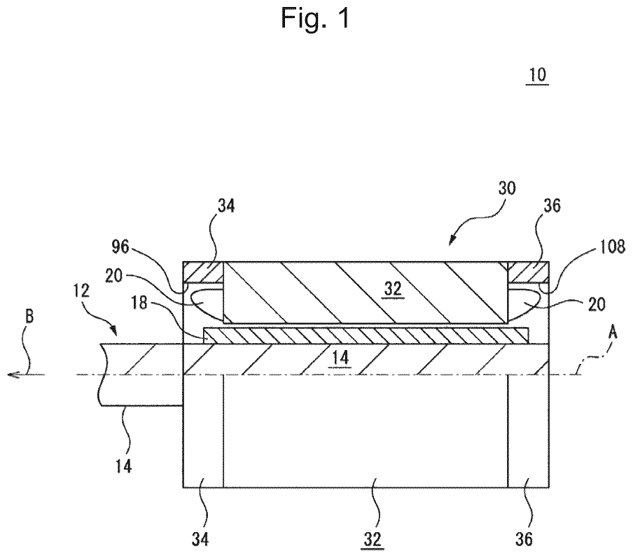

An embodiment of the present disclosure is described in detail below with reference to the drawings. Note that, in various embodiments described below, similar elements are denoted with the same reference numerals, and overlapping description thereof is omitted. First, with reference to FIG. 1, an electric motor 10 according to the embodiment is described. Note that, in the following description, the axial direction is a direction of a rotation axis line A (i.e., a central axis line of a rotor and a stator) of the electric motor 10, the radial direction is a direction of the radius of a circle around the axis line A, and the circumferential direction is a direction of the circumference of the circle. In addition, for convenience of description, the direction of the arrow B in the drawing is referred to as axially frontward.

The electric motor 10 drives into rotation a main shaft of a machine tool, a ball screw of a moving mechanism that moves a workpiece with respect to the main shaft, or a joint shaft of an industrial robot, for example. The electric motor 10 includes a rotor 12 and a stator 30. The rotor 12 is rotatably provided on the inside of the stator 30 in the radial direction. More specifically, the rotor 12 includes a rotation shaft 14 extending in the axial direction, and a rotor core 18 provided in a fixed manner on the outside of the rotation shaft 14 in the radial direction.

The stator 30 includes a stator core 32, a front bracket 34, and a rear bracket 36. The stator core 32 has the axis line A, and a coil 20 is wound on the inside of the stator core 32 in the radial direction. The stator 30 generates a circumferential rotating magnetic field with the voltage applied to the coil 20, thereby generating the power for driving the rotor 12 into rotation in the circumferential direction.

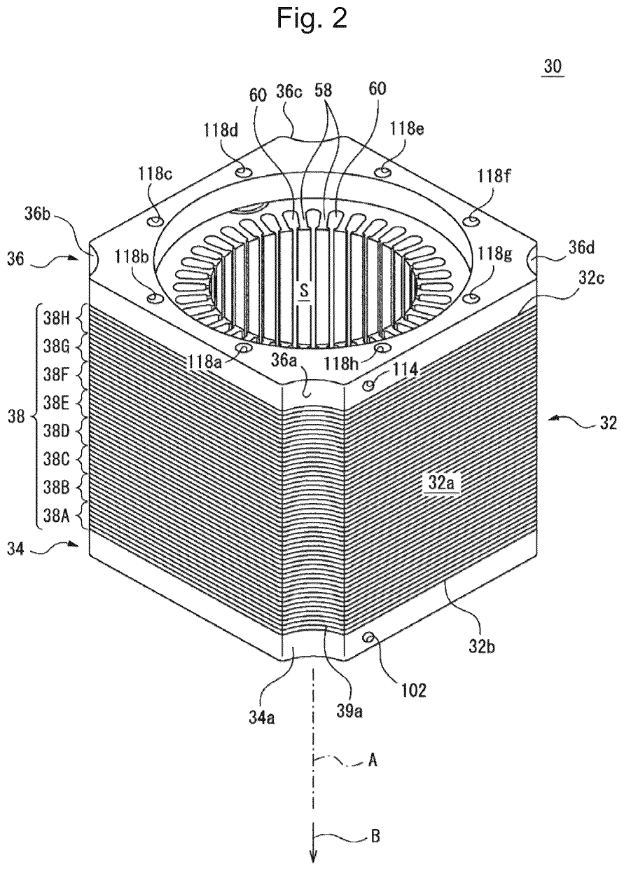

A configuration of the stator 30 is elaborated below with reference to FIGS. 2 to 5. The stator core 32 includes a plurality of core plates 38 stacked in the axial direction. In the present embodiment, the plurality of core plates 38 have the same shape. Each core plate 38 is composed of an electromagnetic steel sheet with a predetermined thickness (e.g., 0.5 mm), for example.

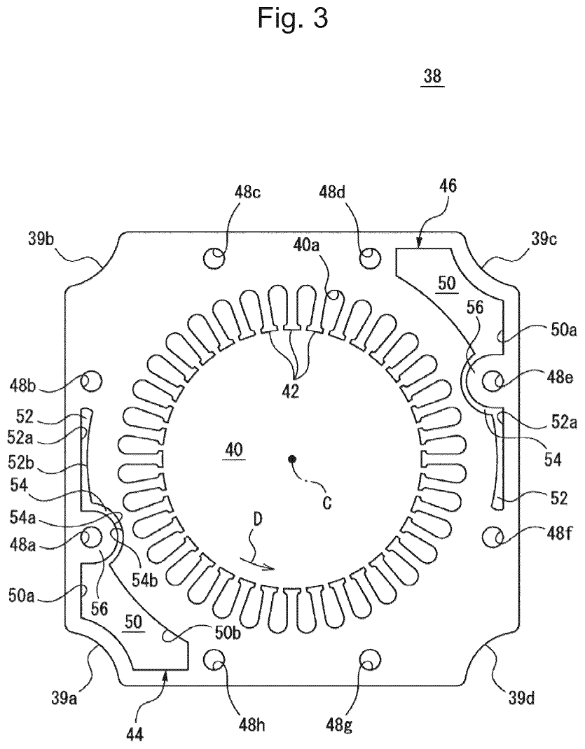

Next, with reference to FIG. 3, a configuration of each core plate 38 is described. Note that, in the following description, one side in the circumferential direction is the direction of an arrow D in FIG. 3, and the other side in the circumferential direction is the opposite direction of the direction of the arrow D. The core plate 38 is a flat plate member with an outer shape of polygon and has a central axis C. In the present embodiment, the core plate 38 has a quadrilateral (more specifically, regular quadrilateral) external shape.

Note that, in the present embodiment, recesses 39a, 39b, 39c and 39d with a curved shape are formed at corner portions of the outer edge of the core plate 38. Specifically, the “polygonal shape” as used herein means a substantially polygonal shape as viewed from the axial direction, and includes shapes with recesses, protrusions, chamfered portions, or R-corner portions formed at the outer edge of a polygon.

The core plate 38 includes the center hole 40, a plurality of protruding parts 42, refrigerant holes 44 and 46, and bolt holes 48a, 48b, 48c, 48d, 48e, 48f, 48g and 48h. Each protruding part 42 protrudes inward in the radial direction from an inner peripheral surface 40a that defines the center hole 40. Each of the refrigerant holes 44 and 46 is a hole being a closed area, and defines a channel that carries a refrigerant CL for cooling the stator 30. Here, the “hole being a closed area” is a hole that is the closed area as viewed in the axial direction as in FIG. 3 (in other words, a hole that is not open to the direction orthogonal to the axial direction, the whole circumference of which is encircled by a surface).

More specifically, the refrigerant hole 44 includes a first hole part 50, a second hole part 52, and a third hole part 54. The first hole part 50 is arranged adjacent to the bolt hole 48a on one side in the circumferential direction, and defined by a surface 50a on the outside in the radial direction and a surface 50b on the inside in the radial direction. The surface 50a extends along (more specifically, parallel to) the outer edge of the core plate 38, whereas the surface 50b is an arc surface around the central axis C.

The second hole part 52 is arranged adjacent to the bolt hole 48a on the other side in the circumferential direction, and defined by a surface 52a on the outside in the radial direction and a surface 52b on the inside in the radial direction. The surface 52a extends along (more specifically, parallel to) the outer edge of the core plate 38, whereas the surface 52b is an arc surface around the central axis C. In this manner, in the present embodiment, the surfaces 50b and 52b on the inside in the radial direction that define the refrigerant hole 44 are arc surfaces. With this configuration, the amount of magnetic flux passing inside the stator core 32 can be effectively maintained.

The third hole part 54 extends in the circumferential direction between the first hole part 50 and the second hole part 52. More specifically, the third hole part 54 extends in an arc shape along the outer periphery of the bolt hole 48a on the inside of the bolt hole 48a in the radial direction, and is defined by a surface 54a on the outside in the radial direction and a surface 54b on the inside in the radial direction. The surface 54b is connected to the surface 50b of the first hole part 50 and the surface 52b of the second hole part 52, and arranged to be curvedly concave inwardly in the radial direction from the surfaces 50a and 52b. Note that, the surfaces 54a and 54b may be arc surfaces with the central axis line of the bolt hole 48a at the center. The first hole part 50, the second hole part 52, and the third hole part 54 fluidly communicate with each other in the circumferential direction, thus making up the refrigerant hole 44 extending in the circumferential direction.

The refrigerant hole 46 has a shape obtained by rotating the refrigerant hole 44 around the central axis C by 180° (i.e., a rotationally symmetrical shape). More specifically, the refrigerant hole 46 includes the first hole part 50 arranged adjacent to the bolt hole 48e on one side in the circumferential direction, the second hole part 52 arranged adjacent to the bolt hole 48e on the other side in the circumferential direction, and the third hole part 54 extending in the circumferential direction between the first hole part 50 and the second hole part 52. The first hole part 50, the second hole part 52, and the third hole part 54 make up the refrigerant hole 46 extending in the circumferential direction.

Each of the bolt holes 48a, 48b, 48c, 48d, 48e, 48f, 48g and 48h does not fluidly communicate with (i.e., is separated from) the refrigerant holes 44 and 46. More specifically, the bolt hole 48a is formed at a semicircular-shaped flange part 56, and therefore does not fluidly communicate with the refrigerant hole 44. The flange part 56 includes the surface 54a that protrudes inward in the radial direction from the surfaces 50a and 52a defining the refrigerant hole 44, and defines the third hole part 54.

Likewise, the bolt hole 48e is formed at the flange part 56 that protrudes from the surfaces 50a and 52a defining the refrigerant hole 46, and therefore does not fluidly communicate with the refrigerant hole 46. Note that, in the present embodiment, a total of eight bolt holes 48a, 48b, 48c, 48d, 48e, 48f, 48g and 48h is formed, but the number of bolt holes 48 is not limited.

Next, with reference to FIGS. 2 to 4, a stacking arrangement of the core plate 38 is described. In the present embodiment, the plurality of core plates 38 making up the stator core 32 includes a first group core plate 38A, a second group core plate 38B, a third group core plate 38C, a fourth group core plate 38D, a fifth group core plate 38E, a sixth group core plate 38F, a seventh group core plate 38G, and an eighth group core plate 38H in this order from the axially front side. Note that, in the present embodiment, the n-th group core plate 38 (n=1, 2, 3, . . . ) is composed of a plurality of (e.g., 30) core plates 38, but may be composed of one core plate 38.

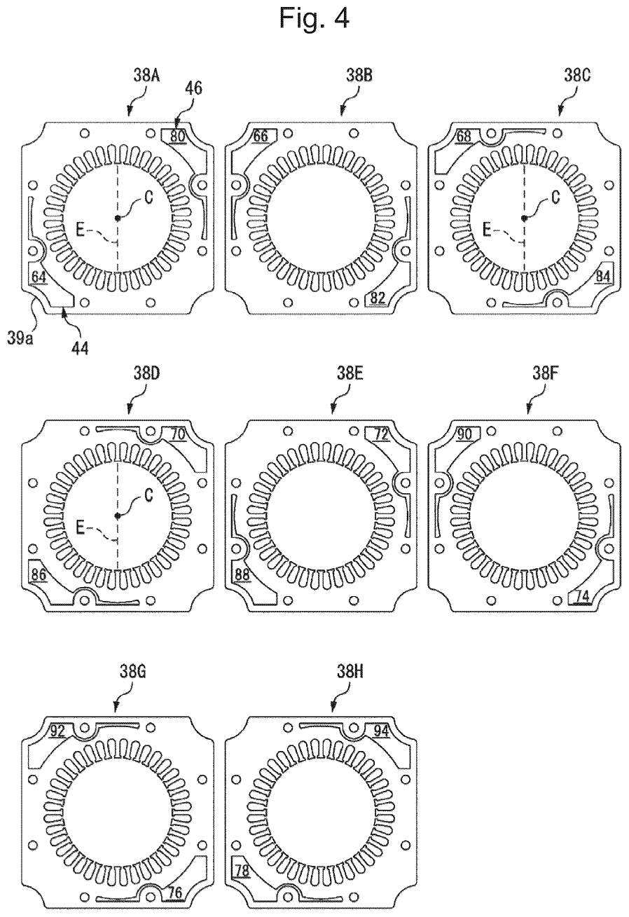

FIG. 4 illustrates the first group core plate 38A to the eighth group core plate 38H in a stacked state. Here, the n+1-th group core plate 38 (second core plate) stacked on the rear side of the n-th group core plate 38 (first core plate) in the axial direction has a shape obtained by inverting the n-th group core plate 38 around a symmetry axis E of its quadrilateral external shape, or by rotating it around the central axis C by the center angle θ (=90°) of the quadrilateral.

For example, as illustrated in FIG. 4, the second group core plate 38B has a shape obtained by inverting the first group core plate 38A by rotating it around the symmetry axis E by 180°. On the other hand, the fifth group core plate 38E has a shape obtained by inverting the fourth group core plate 38D around the symmetry axis E and rotating it around the central axis C by the center angle θ.

Conversely, it can be said that the n-th group core plate 38 (second core plate) stacked on the axially front side of the n+1-th group core plate 38 (first core plate) has a shape obtained by inverting the n+1-th group core plate 38 around the symmetry axis E, or rotating it around the central axis C by the center angle θ. For example, the second group core plate 38B has a shape obtained by inverting the third group core plate 38C around the symmetry axis E and rotating it around the central axis C by the center angle θ.

In this manner, the first group core plate 38A to the eighth group core plate 38H are stacked in the axial direction with the central axes C aligned with each other, and with the outer edges (i.e., the sides) of respective quadrilaterals aligned with each other in the arrangement (i.e., orientation) illustrated in FIG. 4. As a result, as illustrated in FIG. 2, the stator core 32 with the axis line A is formed. In the stator core 32, the protruding parts 42 of the plurality of stacked core plates 38 make up a plurality of teeth 58 arranged in the circumferential direction on the inside of the stator core 32 in the radial direction, and a slot 60 is defined between two teeth 58 adjacent to each other in the circumferential direction. The coil 20 (FIG. 1) is wound around the teeth 58, and accommodated in the slot 60. In addition, the center hole 40 of the plurality of stacked core plates 38 defines an internal space S for housing the rotor core 18.

In addition, with the outer edge of the plurality of stacked core plates 38, the stator core 32 has a polygonal (in the present embodiment, quadrilateral) external shape as viewed in the axial direction. Specifically, the external shape of the core plate 38 is substantially the same as the external shape of the stator core 32. Then, the outer edge that defines one side of the quadrilateral of the plurality of stacked core plates 38 forms an outer surface 32a that defines one side of the external shape of the quadrilateral of the stator core 32. This outer surface 32a is a substantially flat surface extending from one end 32b to the other end 32c of the stator core 32 in the axial direction.

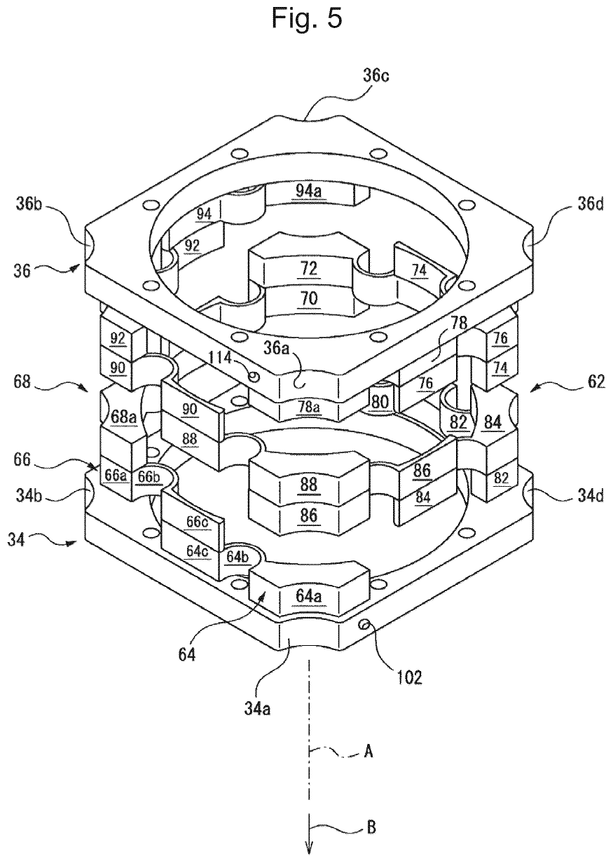

In addition, inside the stator core 32, the refrigerant holes 44 and 46 of the plurality of stacked core plates 38 define a channel 62 through which the refrigerant CL for cooling the stator 30 flows. FIG. 5 illustrates the channel 62. Here, for the sake of description of the channel 62, the channels defined by the refrigerant holes 44 and 46 of the first group core plate 38A are referred to as channels 64 and 80, respectively, as illustrated in FIG. 4.

Likewise, it is assumed that channels 66 and 82 are defined in the second group core plate 38B, channels 68 and 84 in the third group core plate 38C, channels 70 and 86 in the fourth group core plate 38D, channels 72 and 88 in the fifth group core plate 38E, channels 74 and 90 in the sixth group core plate 38F, channels 76 and 92 in the seventh group core plate 38G, and channels 78 and 94 in the eighth group core plate 38H.

In this case, in the channel 62 illustrated in FIG. 5, a channel 64c defined by the second hole part 52 (FIG. 3) in the channel 64 of the first group core plate 38A fluidly communicates with a channel 66c defined by the second hole part 52 in the channel 66 of the second group core plate 38B in the axial direction. On the other hand, a channel 64b defined by the third hole part 54 in the channel 64 of the first group core plate 38A does not fluidly communicate with the refrigerant holes 44 and 46 (or the channel 66) of the second group core plate 38B in the axial direction.

In addition, a channel 66a defined by the first hole part 50 (FIG. 3) in the channel 66 of the second group core plate 38B fluidly communicates with a channel 68a defined by the first hole part 50 in the channel 68 of the third group core plate 38C in the axial direction. On the other hand, a channel 66b defined by the third hole part 54 in the channel 66 of the second group core plate 38B does not fluidly communicate with the refrigerant holes 44 and 46 (or channel 68) of the third group core plate 38C, and the refrigerant holes 44 and 46 (or the channel 64) of the first In this manner, a part of the refrigerant hole 44 or 46 of the n-th group core plate 38 fluidly communicates with the refrigerant hole 44 or 46 of the n+1-th group core plate 38 in the axial direction (or a part of the refrigerant hole 44 or 46 of the n+1-th group core plate 38 fluidly communicates with the refrigerant hole 44 or 46 of the n-th group core plate 38 in the axial direction), and thus as illustrated in FIG. 5, the channel 62 in a spiral shape extending in the circumferential direction and extending stepwise in the axial direction is formed inside the stator core 32.

In addition, the bolt holes 48a, 48b, 48c, 48d, 48e, 48f, 48g and 48h of the core plates 38 of the n-th group and the bolt holes 48a, 48b, 48c, 48d, 48e, 48f, 48g and 48h of the core plates 38 of the n+1-th group fluidly communicate with each other (i.e., aligned) in the axial direction, and thus a through hole extending through the stator core 32 in the axial direction is defined.

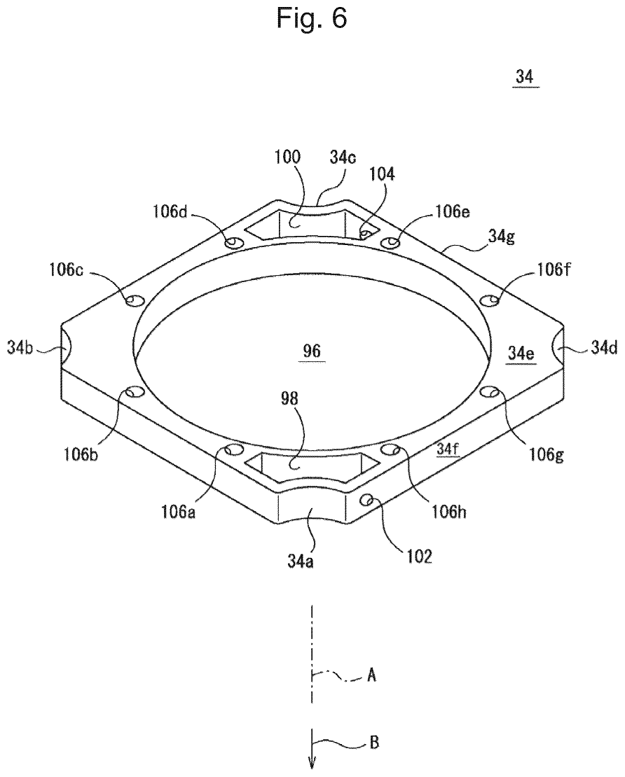

Next, with reference to FIG. 6, the front bracket 34 is described. The front bracket 34 is an annular member composed of iron, and is fixed to the axially front end portion (i.e., the core plate 38A arranged at the axially front end in the first group core plate 38A) of the stator core 32, for example. The front bracket 34 has substantially the same external shape as the stator core 32. Specifically, the front bracket 34 has substantially the same polygonal (quadrilateral) external shape as each core plate 38, and curved recesses 34a, 34b, 34c and 34d are formed at its corner portions. In the present embodiment, the front bracket 34 has a thickness greater than each core plate 38.

The front bracket 34 includes the center hole 96, refrigerant recesses 98 and 100, refrigerant inlets 102 and 104, and bolt holes 106a, 106b, 106c, 106d, 106e, 106f, 106g and 106h. The center hole 96 has a circular shape, and the coil end of the coil 20 (FIG. 1) on the axially front side is housed inside the center hole 96.

The refrigerant recess 98 is formed to be recessed axially frontward from an axially rear end face 34e of the front bracket 34. The refrigerant recess 98 has a shape corresponding to the first hole part 50 (FIG. 3) of the refrigerant hole 44. In a case where the front bracket 34 is fixed to the stator core 32 as illustrated in FIG. 2, the refrigerant recess 98 fluidly communicates with the channel 64a (FIG. 4) defined by the first hole part 50 in the channel 64 of the first group core plate 38A (FIGS. 4 and 5).

The refrigerant recess 100 has a shape (i.e., a rotationally symmetrical shape) obtained by rotating the refrigerant recess 98 around the central axis of the front bracket 34 by 180°. In a case where the front bracket 34 is fixed to the stator core 32 as illustrated in FIG. 2, the refrigerant recess 100 fluidly communicates with a channel 80a (not illustrated) defined by the first hole part 50 in the channel 80 of the first group core plate 38A (FIG. 4).

The refrigerant inlet 102 is formed at an outer surface 34f of the front bracket 34 so as to open outward in the radial direction at the outer surface 34f, and fluidly communicates with the refrigerant recess 98. A hollow coupling CP1 is fixed to the refrigerant inlet 102, and a refrigerant pump PM installed outside the stator 30 (both not illustrated) is fluidly connected to the coupling CP1 through a hose HS1.

On the other hand, the refrigerant inlet 104 is formed at the outer surface 34g of the front bracket 34 so as to open outward in the radial direction at the outer surface 34g, and fluidly communicates with the refrigerant recess 100. A hollow coupling CP2 (not illustrated) is fixed to the refrigerant inlet 104. Each of the bolt holes 106a, 106b, 106c, 106d, 106e, 106f, 106g and 106h is formed to extend through the front bracket 34 in the axial direction, and does not fluidly communicate with (in other words, is separated from) the refrigerant recesses 98 and 100.

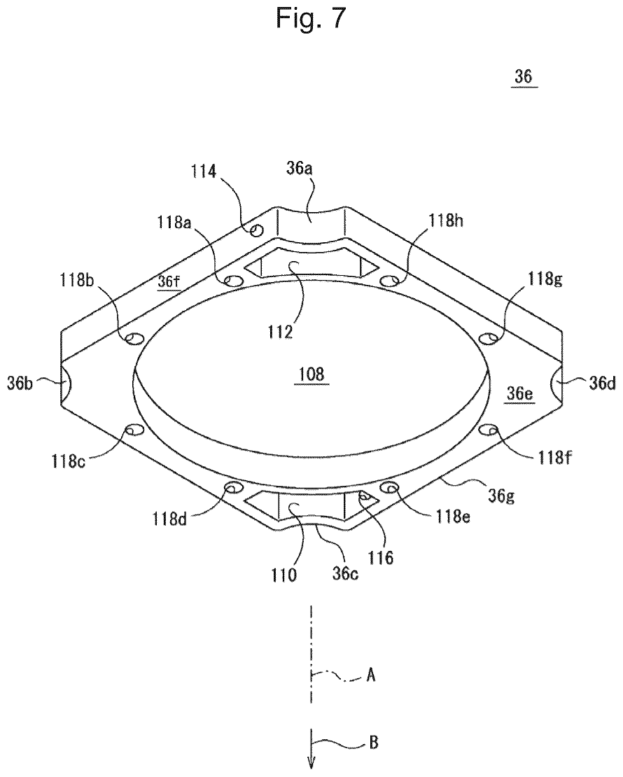

Next, with reference to FIG. 7, the rear bracket 36 is described. The rear bracket 36 is an annular member composed of iron, and is fixed to the axially rear end portion (i.e., the core plate 38H arranged at the axially rear end in the eighth group core plate 38H) of the stator core 32, for example. In the present embodiment, the rear bracket 36 has the same shape as the front bracket 34. As such, the rear bracket 36 has a polygonal (quadrilateral) external shape, and curved recesses 36a, 36b, 36c and 36d are formed at its corner portions.

The rear bracket 36 includes the center hole 108, refrigerant recesses 110 and 112, refrigerant outlets 114 and 116, and bolt holes 118a, 118b, 118c, 118d, 118e, 118f, 118g and 118h. The coil end of the coil 20 (FIG. 1) on the rear side in the axial direction is housed in the center hole 108.

The refrigerant recess 110 is formed to be recessed axially rearward from an axially front end face 36e of the rear bracket 36. As illustrated in FIG. 2, in a case where the rear bracket 36 is fixed to the stator core 32, the refrigerant recess 110 fluidly communicates with a channel 94a defined by the first hole part 50 in the channel 94 of the eighth group core plate 38H (FIG. 4 and 5). On the other hand, the refrigerant recess 112 fluidly communicates with a channel 78a defined by the first hole part 50 in the channel 78 of the eighth group core plate 38H.

The refrigerant outlet 114 is formed at the outer surface 36f so as to open outward in the radial direction at an outer surface 36f of the rear bracket 36, and fluidly communicates with the refrigerant recess 112. A hollow coupling CP3 (not illustrated) is fixed to the refrigerant outlet 114. Here, in the present embodiment, the coupling CP3 is fluidly connected to the coupling CP2 provided in a fixed manner at the refrigerant inlet 104 illustrated in FIG. 6 through a hose HS2 (not illustrated).

On the other hand, the refrigerant outlet 116 is formed at the outer surface 36g so as to open outward in the radial direction at an outer surface 36g of the rear bracket 36, and fluidly communicates with the refrigerant recess 110. A hollow coupling CP4 (not illustrated) is fixed to the refrigerant outlet 116, and the above-described refrigerant pump PM is fluidly connected to the coupling CP4 through a hose HS3. Each of the bolt holes 118a, 118b, 118c, 118d, 118e, 118f, 118g and 118h is formed to extend through the rear bracket 36 in the axial direction, and does not fluidly communicate with the refrigerant recesses 110 and 112.

Next, a method of manufacturing the stator 30 is described. A manufacturer (or manufacture robot) sets a die MD1 for manufacturing the core plate 38 illustrated in FIG. 3 to a press machine PR, and presses an electromagnetic steel sheet serving as a base material using the press machine PR, thereby successively producing the plurality of core plates 38. The manufacturer (or manufacture robot) sequentially picks up the core plate 38 produced by the press machine PR, and stores them in a stacking manner in the axial direction in the arrangement (i.e., same orientation) illustrated in FIG. 3 at a predetermined storage jig JG1. In this manner, the manufacturer produces the plurality of core plates 38 by press working using the common die MD1.

Next, the manufacturer (or manufacture robot) sequentially picks up the core plate 38 from the storage jig JG1, and sets it to an assembly jig JG2 as the first group core plate 38A. Next, the manufacturer (or manufacture robot) sequentially picks up the core plate 38 from the storage jig JG1, inverts the picked-up core plate 38 around the symmetry axis E, and sets it to the assembly jig JG2 as the second group core plate 38B. In this manner, the second group core plate 38B is stacked on the first group core plate 38A at the assembly jig JG2.

Thereafter, the manufacturer (or manufacture robot) repeats the process of sequentially picking up the core plate 38 from the storage jig JG1, inverting the picked-up core plate 38 around its symmetry axis E or rotating it around the central axis C by the center angle θ, and setting it to the assembly jig JG2. As a result, the stator core 32 including the stack of the first group core plate 38A to the eighth group core plate 38H illustrated in FIG. 2 is produced, and the channel 62 is formed inside the stator core 32.

Next, the manufacturer (or manufacture robot) arranges the front bracket 34 on the axially front side of the stator core 32 and arranges the rear bracket 36 on the axially rear side of the stator core 32. Next, the manufacturer (or manufacture robot) inserts a total of eight tie-bolts into the bolt holes 106a, 106b, 106c, 106d, 106e, 106f, 106g and 106h of the front bracket 34, the bolt holes 48a, 48b, 48c, 48d, 48e, 48f, 48g and 48h of the core plates 38 of the stator core 32, and the bolt holes 118a, 118b, 118c, 118d, 118e, 118f, 118g and 118h of the rear bracket 36, and fastens the front bracket 34, the stator core 32, and the rear bracket 36 in the axial direction with the tie-bolts.

In this manner, the stator 30 is produced. Note that, the manufacturer (or manufacture robot) may apply a coating material or a coating agent on the outer surfaces of the front bracket 34, the stator core 32, and the rear bracket 36. Such coating can protect the front bracket 34, the stator core 32, and the rear bracket 36 from the external environment, preventing rust and other problems. In addition, the manufacturer (or manufacture robot) may impregnate the front bracket 34, the stator core 32, and the rear bracket 36 in an impregnating material. Such an impregnating material can firmly fix the coil 20, and prevent the refrigerant CL flowing in the channel 62 in the stator 30 from leaking to the outside as described later.

Next, with reference to FIGS. 4 to 7, a cooling function of the stator 30 is described. During operation of the electric motor 10, the refrigerant pump PM introduces the refrigerant CL into the refrigerant inlet 102 of the front bracket 34 through the hose HS1 and coupling CP1. The refrigerant CL introduced to the refrigerant inlet 102 sequentially flows through the channel 64, the channel 66, the channel 68, the channel 70, the channel 72, the channel 74, the channel 76, and the channel 78, via the refrigerant recess 98. In this manner, the refrigerant CL flows stepwise rearward in the axial direction while spirally flowing in the circumferential direction.

The refrigerant CL that has flowed through the channel 78 flows into the refrigerant recess 112 of the rear bracket 36 and is ejected from the stator 30 through the refrigerant outlet 114. Next, the refrigerant CL flows into the hose HS2 through the coupling CP3, and flows into the refrigerant inlet 104 of the front bracket 34 through the coupling CP2. The refrigerant CL that has entered the refrigerant inlet 104 sequentially flows through the channel 80, the channel 82, the channel 84, the channel 86, the channel 88, the channel 90, the channel 92, and the channel 94 via the refrigerant recess 100.

The refrigerant CL that has flowed through the channel 94 flows into the refrigerant recess 110 of the rear bracket 36, and is ejected from the stator 30 through the refrigerant outlet 116. Thereafter, the refrigerant CL returns to the refrigerant pump PM through the coupling CP4 and the hose HS3. With the above-described refrigerant CL flowing inside the stator 30 (i.e., the front bracket 34, the stator core 32, and the rear bracket 36), the stator 30 can be cooled during operation of the electric motor 10. Note that, the refrigerant CL may be any fluid such as liquid and gas that can cool the stator 30.

As described above, in the present embodiment, the stator core 32 includes the plurality of core plates 38 stacked in the axial direction, and each core plate 38 has a polygonal (more specifically, quadrilateral) external shape and includes the refrigerant holes 44 and 46 being the closed areas that define the channel 62 through which the refrigerant CL flows (i.e., the channels 64, 66, 68, 70, 72, 74, 76, 78, 80, 82, 84, 86, 88, 90, 92, and 94).

The plurality of core plates 38 includes the first core plate 38 (e.g., the first group core plate 38A) and the second core plate 38 (e.g., the second group core plate 38B) stacked on the first core plate 38. Here, the second core plate 38 has a shape obtained by inverting the first core plate 38 around the symmetry axis E, or rotating the first core plate 38 around the central axis C by the center angle θ (=90°). The refrigerant holes 44 and 46 of the first core plate 38 extend in the circumferential direction, and partially fluidly communicate with the refrigerant holes 44 and 46 of the second core plate 38 in the axial direction.

With this configuration, the refrigerant holes 44 and 46 being the closed areas define the channel 62, which eliminates the need for a casing that is fitted on the radial outside of the stator core 32 to form the channel. In addition, the core plate 38 can be mass-produced using the common die MD1, and the stator core 32 can be produced by the simple process of inverting or rotating and stacking the core plate 38. Thus, the manufacturing cost of the stator 30 can be reduced, and the stator 30 can be miniaturized. In addition, the channel 62 is formed to extend in the circumferential direction and the axial direction, and as a result the refrigerant CL flows inside the stator core 32 not only in the axial direction, but also in the circumferential direction. In this manner, the cooling efficiency of the stator 30 can be improved.

In addition, in the present embodiment, the core plate 38 further includes the bolt holes 48a, 48b, 48c, 48d, 48e, 48f, 48g and 48h through which the tie-bolt is inserted, and the bolt holes 48a, 48b, 48c, 48d, 48e, 48f, 48g and 48h do not fluidly communicate with the refrigerant holes 44 and 46. With this configuration, by firmly fastening the core plate 38A to 38H with the tie-bolt, the strength of the stator core 32 can be increased, and the contact between the tie-bolt the refrigerant CL can be avoided.

In addition, in the present embodiment, the refrigerant holes 44 and 46 include the first hole part 50 arranged adjacent to the bolt holes 48a and 48e on one side in the circumferential direction, the second hole part 52 arranged adjacent to the bolt holes 48a and 48e on the other side in the circumferential direction, and the third hole part 54 extending in the circumferential direction between the first hole part 50 and the second hole part 52. With this configuration, the bolt holes 48a and 48e and the refrigerant holes 44 and 46 can be closely arranged, which is advantageous in miniaturizing the stator 30.

In addition, in the present embodiment, the first hole part 50 (e.g., the channel 66a in FIG. 5) or the second hole part 52 (e.g., the channel 64c in FIG. 5) of the first core plate 38 fluidly communicates with the refrigerant hole of the second core plate 38 (e.g., the channel 68a or the channel 66c in FIG. 5) in the axial direction, while the third hole part of the first core plate 38 (e.g., the channel 64b in FIG. 5) does not fluidly communicate with the refrigerant holes 44 and 46 of the second core plate 38 in the axial direction. With this configuration, the channel 62 in a spiral shape extending in the circumferential direction and extending stepwise in the axial direction can be effectively formed.

In the present embodiment, the stator 30 includes the stator core 32, and the brackets 34 and 36 fixed to an end portion of the stator core 32 in the axial direction, and the brackets 34 and 36 include the refrigerant inlets 102 and 104 for introducing the refrigerant CL to the channel 62, or the refrigerant outlets 114 and 116 for ejecting the refrigerant CL that has flowed through the channel 62. With this configuration, the brackets 34 and 36 can be cooled together with the stator core 32, and the arrangement space of the refrigerant inlets 102 and 104 or the refrigerant outlets 114 and 116 can be easily ensured.

In addition, in the manufacturing method for the stator core 32, the manufacturer (or manufacture robot) produces the plurality of core plates 38 by press working using the common die MD1, picks up and sets one of the plurality of produced core plates 38 to the jig JG2 as the first core plate 38 (e.g., the first group core plate 38A). Next, the manufacturer (or manufacture robot) picks up a different one of the plurality of produced core plates 38, inverts the different one around its symmetry axis E or rotates it around the central axis C by the center angle θ, and stacks it as the second core plate 38 (e.g., the second group core plate 38B) on the first core plate 38 set to the jig JG2.

In this manner, a part of the refrigerant holes 44 and 46 of the first core plate 38 (e.g., the channel 64c in FIG. 5) fluidly communicates with the refrigerant holes 44 and 46 of the second core plate 38 (e.g., the channel 66c in FIG. 5) in the axial direction, thereby forming the channel 62. With this method, the first core plate 38 can be mass-produced by using the common die MD1, and the stator core 32 can be produced by the simple process of inverting or rotating and stacking the core plate 38. In this manner, the efficiency of the manufacturing process for the stator 30 can be enhanced.

Note that, the above-described hose HS1 may be connected to the refrigerant outlet 114 such that the refrigerant outlet 114 functions as a refrigerant inlet, and the refrigerant CL is introduced from the refrigerant outlet 114. In this case, the refrigerant inlet 102 functions as a refrigerant outlet and ejects the refrigerant CL. In addition, in this case, the coupling CP1 of the refrigerant inlet 102 and a coupling CL4 of the refrigerant outlet 116 may be connected to each other by the hose HS2. In this case, the refrigerant outlet 116 serves as a refrigerant inlet, and the refrigerant inlet 104 serves as a refrigerant outlet. The above-described hose HS3 is connected to that refrigerant outlet 104, and the refrigerant is ejected to the refrigerant outlet 104 toward the pump PM.

Alternatively, in a case where introducing the refrigerant CL from the refrigerant outlet 114, the coupling CP1 of the refrigerant inlet 102 and the coupling CL2 of the refrigerant inlet 104 may be connected to each other by the hose HS2. In this case, the refrigerant is ejected from the refrigerant outlet 116 toward the pump PM. Specifically, in this case, the refrigerant outlet 116 and the refrigerant inlet (in this example, the refrigerant outlet 114) connected to the pump PM may be formed at a rear bracket 136.

In addition, the hose HS2 may be omitted. For example, in the front bracket 34, a fluid communication recess that extends in the circumferential direction between the refrigerant recess 98 and the refrigerant recess 100 and fluidly communicates between the refrigerant recesses 98 and 100 is formed. In this case, in a case where the refrigerant CL is introduced from the refrigerant outlet 114, the refrigerant CL that has entered the refrigerant recess 98 flows into the refrigerant recess 100 through the fluid communication recess so as to be ejected from the refrigerant outlet 116 toward the pump PM.

Note that, a plurality of the core plates 38 may be stacked with the refrigerant hole 44 or 46 omitted from the core plate 38, and the channels 80, 82, 84, 86, 88, 90, 92 and 94 omitted from the channel 62. In this case, the refrigerant recess 100 and the refrigerant inlet 104 may be omitted from the front bracket 34, and the refrigerant recess 110 and the refrigerant outlet 116 may be omitted from the rear bracket 36.

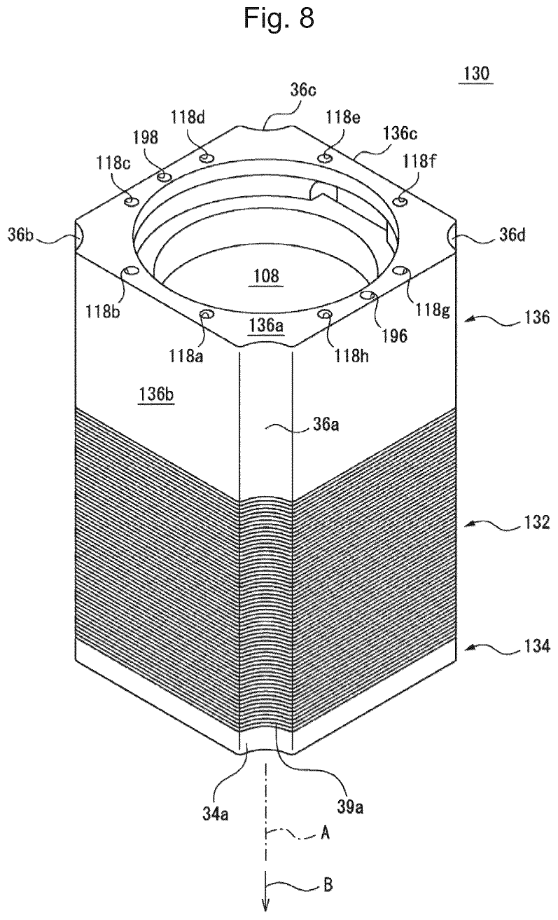

Next, with reference to FIGS. 8 to 13, a stator 130 according to another embodiment is described. The stator 130 may be applied to the electric motor 10 instead of the above-described stator 30. The stator 130 includes a stator core 132, a front bracket 134, and the rear bracket 136. The stator core 132 includes a plurality of core plates 138 stacked in the axial direction. The plurality of core plates 138 is composed of electromagnetic steel sheets with the same shape and a predetermined thickness (e.g., 0.5 mm).

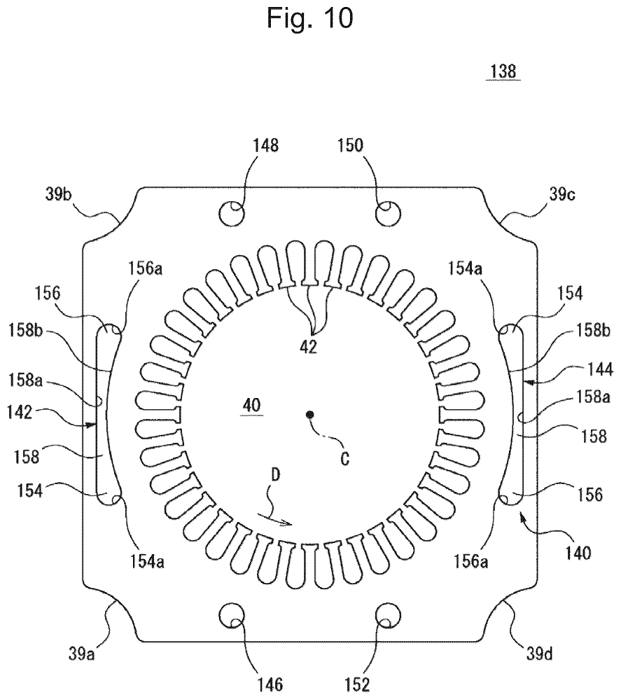

A configuration of each core plate 138 is described below with reference to FIG. 10. As with the above-described core plate 138, the core plate 138 has a polygonal (more specifically, regular quadrilateral) external shape, and recesses 39a, 39b, 39c and 39d are formed at corner portions of its outer edge. The core plate 138 includes the center hole 40, the protruding part 42, and a refrigerant hole 140.

The refrigerant hole 140 includes elongate holes 142 and 144, and circular holes 146, 148, 150 and 152. The elongate holes 142 and 144 and the circular holes 146, 148, 150 and 152 are holes being the closed areas, and define a channel that carries the refrigerant CL. The elongate hole 142 includes a first hole part 154, a second hole part 156, and a third hole part 158.

The first hole part 154 and the second hole part 156 are defined by an arc surfaces 154a and 156a, respectively, with a predetermined curvature radius R1. The third hole part 158 extends in the circumferential direction between the first hole part 154 and the second hole part 156. The third hole part 54 is defined by a surface 158a on the outside in the radial direction and a surface 158b on the inside in the radial direction.

The surface 158a extends along (more specifically, parallel to) the outer edge of the core plate 138, and the surface 158b is an arc surface around the central axis C. In this manner, the surface 158b on the inside in the radial direction that defines the elongate hole 142 is provided as an arc surface, and thus the amount of magnetic flux passing inside the stator core 132 can be effectively maintained. The first hole part 154, the second hole part 156, and the third hole part 158 fluidly communicate with each other in the circumferential direction, thus making up the elongate hole 142 extending in the circumferential direction.

The elongate hole 144 has a shape obtained by rotating the elongate hole 142 around the central axis C by 180° (i.e., a rotationally symmetrical shape). More specifically, the elongate hole 144 includes the first hole part 154, the second hole part 156, and the third hole part 158. The circular holes 146, 148, 150 and 152, each with a predetermined radius R2, are arranged away from the elongate holes 142 and 144 in the circumferential direction. Note that, the radius R2 of the circular holes 146, 148, 150 and 152 may be substantially the same as the radius R1 of the first hole part 154 and the second hole part 156 of the elongate holes 142 and 144 (R1=R2).

Here, in the present embodiment, the radiuses R1 and R2 are set to values smaller than a radius R3 of the head part of the tie-bolt for fastening the stator core 132, the front bracket 134, and the rear bracket 136, and greater than a radius R4 of the shaft part of tie-bolt (R4<R1 and R2<R3). However, this is not limitative, and the radiuses R1 and R2 may be set to values greater than the radius R3 of the head part of the tie-bolt (R3 and R4<R1 and R2).

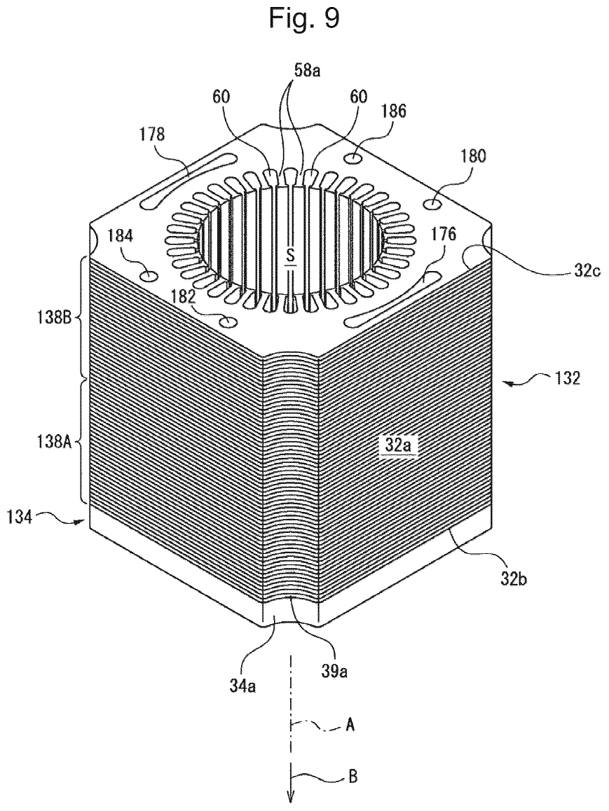

Next, with reference to FIGS. 9 to 11, a stacking arrangement of the core plate 138 is described. In the present embodiment, the plurality of core plates 138 making up the stator core 132 includes a first group core plate 138A and a second group core plate 138B in this order from the axially front side. Note that, in the present embodiment, each of the first group core plate 138A and the second group core plate 138B is composed of a plurality of (e.g., 120) core plates 138, but may be composed of a single core plate 138.

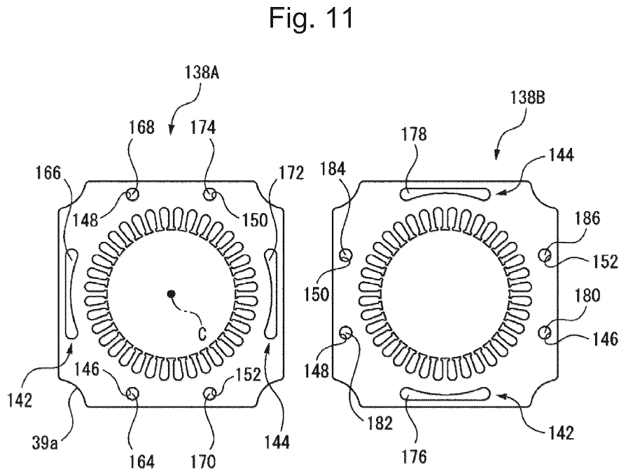

FIG. 11 illustrates the first group core plate 138A and the second group core plate 138B in a stacked state. The second group core plate 138B (second core plate) stacked on the rear side of the first group core plate 138A (first core plate) in the axial direction has a shape obtained by rotating the first group core plate 138A around its central axis C by the center angle θ (=90°) to one side (or the other side) in the circumferential direction. Conversely, it can be said that the first group core plate 138A (second core plate) stacked on the axially front side of the second group core plate 138B (first core plate) has a shape obtained by rotating the second group core plate 138B around the central axis C by the center angle θ to one side in the circumferential direction.

In this manner, the first group core plate 138A and the second group core plate 138B are stacked in the axial direction with the central axes C aligned with each other, and with the outer edges (i.e., the sides) of respective quadrilaterals aligned with each other in the arrangement illustrated in FIG. 11. As a result, as illustrated in FIG. 9, the stator core 132 with the axis line A is formed. As with the above-described stator core 32, the stator core 132 includes the teeth 58, the slot 60, the internal space S, and the outer surface 32a extending from the one end 32b to the other end 32c of the stator core 132 in the axial direction.

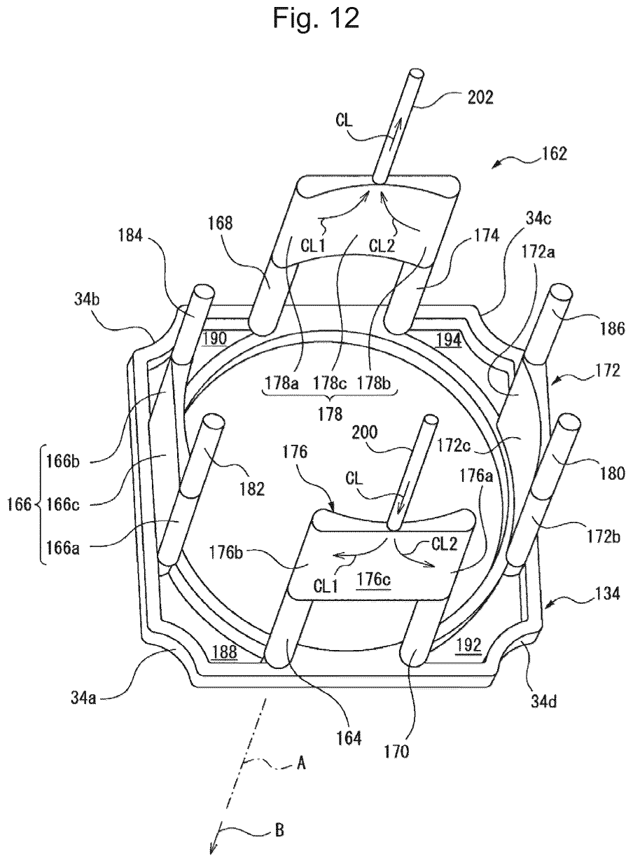

In addition, the refrigerant hole 140 of the plurality of stacked core plates 138 defines a channel 162 through which the refrigerant CL flows. FIG. 12 illustrates the channel 162. Here, for the sake of description of the channel 162, the channels defined by the elongate holes 142 and 144 of the first group core plate 138A are referred to as channels 166 and 172, respectively as illustrated in FIG. 11.

In addition, the channels defined by the circular holes 146, 148, 150 and 152 are referred to as channels 164, 168, 174 and 170, respectively. Likewise, it is assumed that channels 176 and 178 corresponding to the elongate holes 142 and 144 and channels 180, 182, 184 and 186 corresponding to the circular holes 146, 148, 150 and 152 are defined in the second group core plate 138B.

In this case, in the channel 166 of the first group core plate 138A in the channel 162 illustrated in FIG. 12, a channel 166a defined by the first hole part 154 (FIG. 10) fluidly communicates with the channel 182 defined by a circular hole 148 of the second group core plate 138B in the axial direction. In addition, in the channel 166 of the first group core plate 138A, a channel 166b defined by the second hole part 156 fluidly communicates with the channel 184 defined by the circular hole 150 of the second group core plate 138B in the axial direction. On the other hand, in the channel 166 of the first group core plate 138A, a channel 166c defined by the third hole part 158 does not fluidly communicate with the refrigerant hole 140 of the second group core plate 138B (or the channels 182 and 184) in the axial direction.

Likewise, in the channel 172 of the first group core plate 138A, a channel 172a defined by the first hole part 154 fluidly communicates with the channel 186 defined by the circular hole 152 of the second group core plate 138B in the axial direction. In addition, in the channel 172 of the first group core plate 138A, a channel 172b defined by the second hole part 156 fluidly communicates with the channel 180 defined by the circular hole 146 of the second group core plate 138B in the axial direction. On the other hand, in the channel 172 of the first group core plate 138A, a channel 172c defined by the third hole part 158 does not fluidly communicate with the refrigerant hole 140 of the second group core plate 138B (or the channels 180 and 186) in the axial direction.

On the other hand, in the channel 176 of the second group core plate 138B, a channel 176a defined by the first hole part 154 fluidly communicates with the channel 170 defined by the circular hole 152 of the first group core plate 138A in the axial direction. In addition, in the channel 176 of the second group core plate 138B, a channel 176b defined by the second hole part 156 fluidly communicates with the channel 164 defined by the circular hole 146 the first group core plate 138A in the axial direction. On the other hand, in the channel 176 of the second group core plate 138B, a channel 176c defined by the third hole part 158 does not fluidly communicate with the refrigerant hole 140 of the first group core plate 138A (or the channels 164 and 170) in the axial direction.

In addition, in the channel 178 of the second group core plate 138B, a channel 178a defined by the first hole part 154 fluidly communicates with the channel 168 defined by the circular hole 148 of the first group core plate 138A in the axial direction. In addition, in the channel 178 of the second group core plate 138B, a channel 178b defined by the second hole part 156 fluidly communicates with the channel 174 defined by the circular hole 150 of the first group core plate 138A in the axial direction. On the other hand, in the channel 178 of the second group core plate 138B, a channel 178c defined by the third hole part 158 does not fluidly communicate with the refrigerant hole 140 of the first group core plate 138A (or the channels 168 and 174) in the axial direction.

In this manner, a part of the refrigerant hole 140 of the first group core plate 138A (more specifically, the elongate holes 142 and 144) fluidly communicates with the refrigerant hole 140 of the second group core plate 138B (more specifically, the circular holes 146, 148, 150 and 152) in the axial direction (or a part of the refrigerant hole 140 of the second group core plate 138B fluidly communicates with the refrigerant hole 140 of the first group core plate 138A in the axial direction), and thus the channel 162 extending in the circumferential direction and extending in the axial direction is formed inside the stator core 132 as illustrated in FIG. 12.

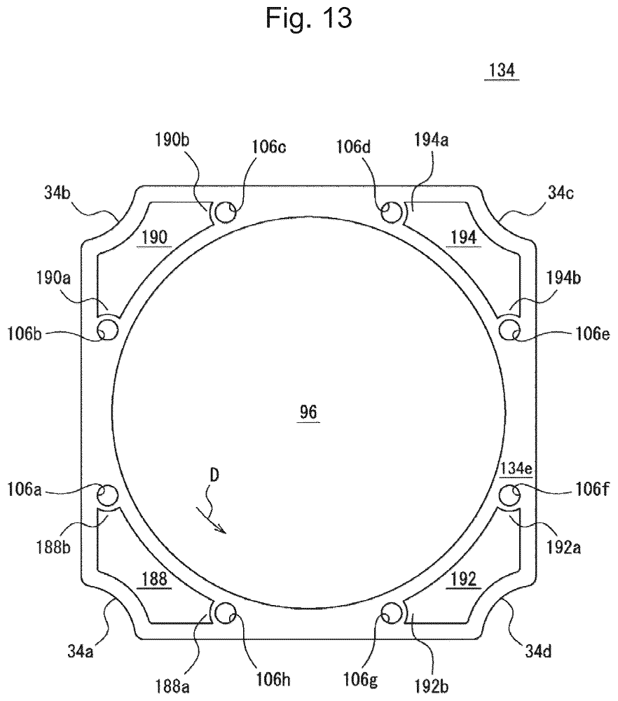

Next, with reference to FIG. 13, the front bracket 134 is described. The front bracket 134 is an annular member composed of iron, and is fixed to the axially front end portion (i.e., the core plate 138A arranged at the axially front end in the first group core plate 138A) of the stator core 132, for example. The front bracket 134 has substantially the same polygonal (quadrilateral) external shape as the stator core 132, and recesses 34a, 34b, 34c and 34d are formed at its corner portions.

The front bracket 134 includes the center hole 96 and the bolt holes 106a, 106b, 106c, 106d, 106e, 106f, 106g and 106h similar to those of the above-described front bracket 34, and refrigerant recesses 188, 190, 192 and 194. Each of the refrigerant recesses 188, 190, 192 and 194 is formed to be recessed axially frontward from an axially rear end face 134e of the front bracket 134, and extends in the circumferential direction. The refrigerant recesses 188, 190, 192 and 194 are arranged adjacent to respective corner portions of the quadrangular front bracket 134.

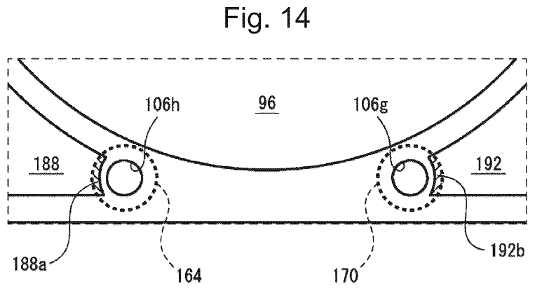

As illustrated in FIGS. 8 and 9, in a case where the front bracket 134 is fixed to the stator core 132, the refrigerant recess 188 fluidly communicates with the channel 164 of the first group core plate 138A (FIG. 12) in the axial direction. More specifically, as illustrated in FIG. 14, the refrigerant recess 188 fluidly communicates with the channel 164 in the axial direction at its one end portion 188a in the circumferential direction as illustrated as the shaded area in the drawing.

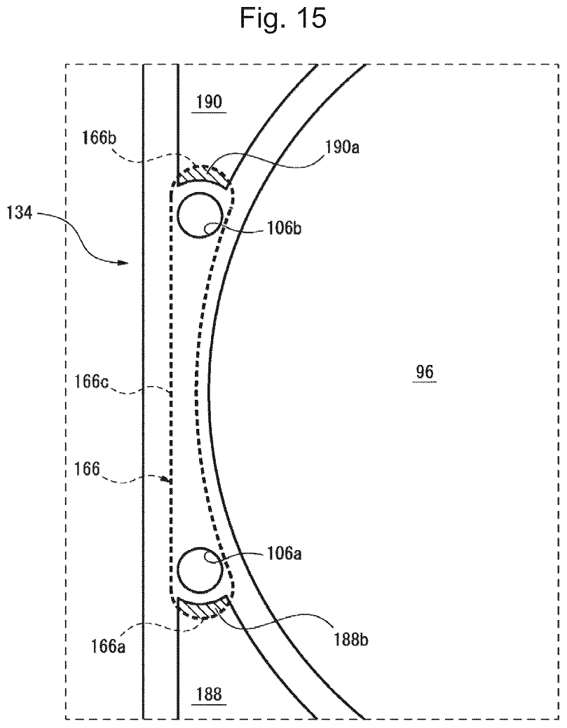

On the other hand, the refrigerant recess 188 fluidly communicates with the channel 166 of the first group core plate 138A in the axial direction. More specifically, as illustrated in FIG. 15, the refrigerant recess 188 fluidly communicates with the channel 166a in the axial direction at its other end portion 188b in the circumferential direction as illustrated as the shaded area in the drawing. Likewise, the refrigerant recess 190 fluidly communicates with the channel 166b of the first group core plate 138A in the axial direction at its one end portion 190a in the circumferential direction, and fluidly communicates with the channel 168 of the first group core plate 138A in the axial direction at its other end portion 190b in the circumferential direction (FIG. 13).

In addition, the refrigerant recess 192 fluidly communicates with the channel 172b of the first group core plate 138A in the axial direction at its one end portion 192a in the circumferential direction, and fluidly communicates with the channel 170 of the first group core plate 138A in the axial direction at its other end portion 192b in the circumferential direction. In addition, the refrigerant recess 194 fluidly communicates with the channel 174 of the first group core plate 138A in the axial direction at its one end portion 194a in the circumferential direction, and fluidly communicates with the channel 172a of the first group core plate 138A in the axial direction at its other end portion 194b in the circumferential direction.

In this manner, the refrigerant recesses 188, 190, 192 and 194, the channels 164, 166, 168, 170, 172 and 174 of the first group core plate 138A and the channels 176, 178, 180, 182, 184 and 186 of the second group core plate 138B fluidly communicate with each other, thus defining the channel 162 extending in the circumferential direction and the axial direction.

Next, with reference to FIG. 8, the rear bracket 136 is described. The rear bracket 136 is an annular member composed of iron, and is fixed to the axially rear end portion (i.e., the core plate 138H arranged at the axially rear end in the second group core plate 138B) of the stator core 132, for example. The rear bracket 136 has the same polygonal (quadrilateral) external shape as the front bracket 134, and recesses 36a, 36b, 36c and 36d are formed at its corner portions.

The rear bracket 136 includes the center hole 108 and the bolt holes 118a, 118b, 118c, 118d, 118e, 118f, 118g and 118h similar to those of the above-described rear bracket 36, and a refrigerant inlet 196 and a refrigerant outlet 198. Each of the refrigerant inlet 196 and the refrigerant outlet 198 is formed of a through hole extending through the rear bracket 136 in the axial direction, and is open axially rearward at an axially rear end face 136a of the rear bracket 136.

A hollow coupling CP5 is fixed to the refrigerant inlet 196, and the refrigerant pump PM is fluidly connected to the coupling CP5 through the hose HS1. The refrigerant inlet 196 defines a channel 200 (FIG. 12). As illustrated in FIG. 8, in a case where the rear bracket 136 is fixed to the stator core 132, the channel 200 fluidly communicates with the channel 176c of the second group core plate 138B in the axial direction.

On the other hand, a hollow coupling CP6 is fixed to the refrigerant outlet 198, and the refrigerant pump PM is fluidly connected to the coupling CP6 through the hose HS3, for example. The refrigerant outlet 198 defines a channel 202 (FIG. 12). In a case where the rear bracket 136 is fixed to the stator core 132, the channel 202 fluidly communicates with the channel 178c of the second group core plate 138B in the axial direction.

Next, a manufacturing method for the stator 130 is described. The manufacturer (or manufacture robot) successively produces the plurality of core plates 138 by setting a die MD2 for manufacturing the core plate 138 illustrated in FIG. 10 to the press machine PR and pressing an electromagnetic steel sheet serving as a base material with the press machine PR. The manufacturer (or manufacture robot) sequentially picks up the core plate 138 produced by the press machine PR, and stores them in a stacking manner in the axial direction in the arrangement (i.e., same orientation) illustrated in FIG. 10 at a predetermined storage jig JG3. In this manner, the manufacturer produces the plurality of core plates 138 by press working using the common die MD2.

Next, the manufacturer (or manufacture robot) sequentially picks up the core plate 138 from the storage jig JG3, and sets it to an assembly jig JG4 as the first group core plate 138A. Next, the manufacturer (or manufacture robot) sequentially picks up the core plate 138 from the storage jig JG3, rotates the picked-up core plate 138 around its central axis C by the center angle θ (=90°), and sets it to the assembly jig JG4 as the second group core plate 138A. In this manner, the second group core plate 138B is stacked on the first group core plate 138A at the assembly jig JG4. In this manner, the stator core 132 including the stack of the first group core plate 138A and the second group core plate 138B illustrated in FIG. 9 is produced, and the channel 162 is formed inside the stator core 132.

Next, the manufacturer (or manufacture robot) arranges the front bracket 134 on the axially front side of the stator core 132. At this time, the bolt holes 106a, 106b, 106c, 106d, 106e, 106f, 106g and 106h of the front bracket 134 fluidly communicate with the channels 166a, 166b, 168, 174, 172a, 172b, 170 and 164 of the first group core plate 138A in the axial direction, respectively.

In addition, the manufacturer (or manufacture robot) arranges the rear bracket 136 on the axially rear side of the stator core 132. At this time, the bolt holes 118a, 118b, 118c, 118d, 118e, 118f, 118g and 118h of the rear bracket 136 fluidly communicate with the channels 182, 184, 178a, 178b, 186, 180, 176a and 176b of the second group core plate 138B in the axial direction, respectively.

In this manner, in the present embodiment, the bolt holes 106a, 106b, 106c, 106d, 106e, 106f, 106g and 106h of the front bracket 134, a part of the channel 162 of the stator core 132, and the bolt holes 118a, 118b, 118c, 118d, 118e, 118f, 118g and 118h of the rear bracket 136 fluidly communicate with each other in the axial direction.

Next, the manufacturer (or manufacture robot) inserts a total of eight tie-bolts into the bolt holes 106a, 106b, 106c, 106d, 106e, 106f, 106g and 106h of the front bracket 134, and the bolt holes 118a, 118b, 118c, 118d, 118e, 118f, 118g and 118h of the rear bracket 136.

For example, the manufacturer (or manufacture robot) inserts a single tie-bolt into the bolt hole 106a of the front bracket 134, the channel 166a of the first group core plate 138A (i.e., the first hole part 154 of the elongate hole 142), the channel 182 of the second group core plate 138B (i.e., the circular hole 148), and the bolt hole 118a of the rear bracket 136 that fluidly communicate with each other in the axial direction. As a result, the shaft part of the tie-bolt is arranged through the inside of the channels 166a and 182.

Here, as described above, the radius R1 of the first hole part 154 that defines the channel 166a and the radius R2 of the circular hole 148 that defines the channel 182 are set to values greater than the radius R4 of the shaft part of the tie-bolt (R4<R1 and R2). In this manner, even in a case where the shaft part of the tie-bolt is inserted into the channels 166a and 182, the refrigerant CL can flow inside the channels 166a and 182.

Likewise, the manufacturer (or manufacture robot) inserts a single tie-bolt into the bolt hole 106h of the front bracket 134, the channel 164 of the first group core plate 138A (i.e., the circular hole 146), the channel 176b of the second group core plate 138B (i.e., the second hole part 156 of the elongate hole 142), and the bolt hole 118h of the rear bracket 136 that fluidly communicate with each other in the axial direction, for example. In this case, the shaft part of the tie-bolt will be inserted into the channels 164 and 176b, but the above-described relationship of R4<R1 and R2 allows the refrigerant CL to flow inside the channels 164 and 176b.

In this manner, the front bracket 134, the stator core 132, and the rear bracket 136 are fastened in the axial direction with the total of eight tie-bolts, and thus the stator 130 is produced. Note that, as in the above-described the embodiment, the manufacturer (or manufacture robot) may apply a coating material or a coating agent on the outer surfaces of the front bracket 134, the stator core 132, and the rear bracket 136. In addition, the manufacturer (or manufacture robot) may impregnate the front bracket 134, the stator core 132, and the rear bracket 136 in an impregnating material.

Next, a cooling function of the stator 130 is described. During operation of the electric motor 10, the refrigerant pump PM introduces the refrigerant CL to the refrigerant inlet 196 of the front bracket 134 through the hose HS1 and the coupling CP5 described above. The refrigerant CL introduced to the refrigerant inlet 196 flows into the channel 176c of the second group core plate 138B through the channel 200 (FIG. 12). The refrigerant CL that has entered the channel 176c separates into a first refrigerant flow CL1 flowing to the other side in the circumferential direction and a second refrigerant flow CL2 flowing to one side in the circumferential direction.

The first refrigerant flow CL1 flows from the channel 176b of the second group core plate 138B into the channel 164 of the first group core plate 138A and then into the refrigerant recess 188 of the front bracket 134. Then, the first refrigerant flow CL1 flows from the refrigerant recess 188 into the channel 166c through the channel 166a of the first group core plate 138A. At this time, a part of the first refrigerant flow CL1 flows into the channel 182 of the second group core plate 138B.

The first refrigerant flow CL1 that has entered the channel 166c flows from the channel 166c into the channel 166b. At this time, a part of the first refrigerant flow CL1 flows into the channel 184 of the second group core plate 138B. The first refrigerant flow CL1 that has entered the channel 166b flows into the refrigerant recess 190 of the front bracket 134, and then into the channel 178a of the second group core plate 138B through the channel 168 of the first group core plate 138A.

Likewise, the second refrigerant flow CL2 flows through the channel 176a, the channel 170, the refrigerant recess 192, the channel 172b, the channel 180, the channel 172c, the channel 172a, the channel 186, the refrigerant recess 194, and the channel 174, and flows into the channel 178b. The first refrigerant flow CL1 that has entered the channel 178a and the second refrigerant flow CL2 that has entered the channel 178b join at the channel 178c, and flow into the channel 202.

Then, the refrigerant CL passed inside the channel 202 is ejected from the stator 130 through the refrigerant outlet 198, and returned to the refrigerant pump PM through the coupling CP6 and the hose HS3. The refrigerant CL that flows inside the stator 130 (i.e., the front bracket 134, the stator core 132, and the rear bracket 136) in this manner can cool the stator 130 during operation of the electric motor 10.

As described above, in the present embodiment, the stator core 132 includes the plurality of core plates 138 stacked in the axial direction, and each core plate 138 has an outer shape of polygon and includes the refrigerant hole 140 being the closed area that defines the channel 162 of the refrigerant CL (i.e., the channels 164, 166, 168, 170, 172, 174, 176, 178, 180, 182, 184 and 186).

The plurality of core plates 138 includes a first core plate 138 (e.g., the first group core plate 138A) and a second core plate 138 (e.g., the second group core plate 138B) stacked on the first core plate 138. The second core plate 138 has a shape obtained by rotating the first core plate 138 around its central axis C by the center angle θ (=90°). The refrigerant hole 140 (the elongate holes 142 and 144) of the first core plate 138 extends in the circumferential direction, and partially fluidly communicates with the refrigerant hole 140 (the circular holes 146, 148, 150 and 152) of the second core plate 138B in the axial direction.

As with the above-described stator core 32, this configuration eliminates the need for the casing, and the core plate 138 can be mass-produced by using the common die MD2, and the stator core 132 can be produced through a simple step of rotating and stacking the core plate 138. In this manner, the manufacturing cost of the stator 130 can be reduced, and the stator 130 can be miniaturized. In addition, with the channel 162 extending in the circumferential direction and extending in the axial direction, the cooling efficiency of the stator 130 can be improved.

In addition, in the present embodiment, the refrigerant hole 140 includes the elongate holes 142 and 144 extending in the circumferential direction, and the circular holes 146, 148, 150 and 152 arranged separate from the elongate holes 142 and 144 in the circumferential direction. The elongate holes 142 and 144 (e.g., the channel 166a) of the first core plate 138 and the circular holes 146, 148, 150 and 152 (e.g., the channel 182) of the second core plate 138 fluidly communicate with each other in the axial direction, and the tie-bolt is inserted into the elongate holes 142 and 144 and the circular holes 146, 148, 150 and 152. With this configuration, a part of the refrigerant hole 140 can be used as a bolt hole into which the tie-bolt is to be inserted. In this manner, the bolt hole may be omitted, and the refrigerant hole 140 can be closely arranged, which is advantageous in miniaturizing the stator 130.

In addition, in the present embodiment, the bracket 136 includes the refrigerant inlet 196 for introducing the refrigerant CL to the channel 162, and the refrigerant outlet 198 for ejecting the refrigerant CL that has flowed through the channel 162. The refrigerant inlet 196 and the refrigerant outlet 198 provided in a single bracket 136 in this manner can simplify the wiring structure of the hoses HS1 and HS3 connected to the refrigerant inlet 196 and the refrigerant outlet 198, and increase the ease of the process of connecting the hoses HS1 and HS3 to the refrigerant inlet 196 and the refrigerant outlet 198.

Note that, in the present embodiment, the refrigerant inlet 196 and the refrigerant outlet 198 are formed at the axially rear end face 136a of the rear bracket 136 so as to fluidly communicate with the channel 176c of the second group core plate 138B and 178c, respectively. However, this is not limitative, and the refrigerant inlet 196 and the refrigerant outlet 198 may be formed to fluidly communicate with the channel 180, 182, 184 or 186 of the second group core plate 138B (i.e., the circular hole 146, 148, 150 or 152 of the core plate 138).

For example, the refrigerant inlet 196 may be formed at an outer surface 136b (FIG. 8) of the rear bracket 136 so as to fluidly communicate with the channel 182 through the bolt hole 118a. In addition, the refrigerant outlet 198 may be formed at an outer surface 136c of the rear bracket 136 so as to fluidly communicate with the channel 186 through the bolt hole 118e. In this case, the bolt holes 118b and 118e may be formed with the above-described radiuses R1 or R2.

Note that, the refrigerant hole 140 of the core plate 138 and the refrigerant holes 44 and 46 of the core plate 38 of the above-described embodiment are merely examples, and may be holes with any other shapes. In addition, the bolt holes 48a, 48b, 48c, 48d, 48e, 48f, 48g and 48h may be omitted from the above-described core plate 38. In this case, the plurality of stacked core plates 38 may be fixed in the axial direction with the casing, for example. In this case, the number of components increases, but the above-described reduction of manufacturing cost can be achieved.

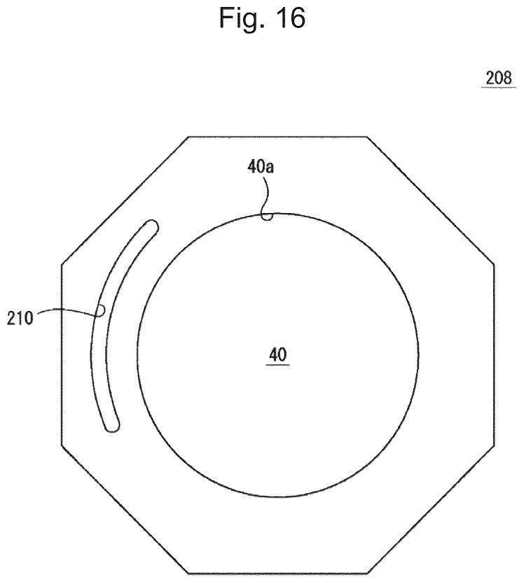

In addition, in the above-described embodiment, the core plates 38 and 138 have quadrilateral (more specifically, regular quadrilateral) external shapes. However, this is not limitative, and the core plate 38 or 138 may have a polygonal (e.g., regular m-square: m=3, 5, 6, 8, . . . ) external shape other than a quadrangle. FIG. 16 illustrates this configuration.

A core plate 208 illustrated in FIG. 16 has an octagonal (more specifically, regular octagonal) external shape. The core plate 208 includes the center hole 40 and a refrigerant hole 210. Note that, although not illustrated in the drawing, the above-described protruding parts 42 are arranged in the circumferential direction at the inner peripheral surface 40a that defines the center hole 40. In the present embodiment, the refrigerant hole 210 is an elongate hole extending in an arc-shape in the circumferential direction.

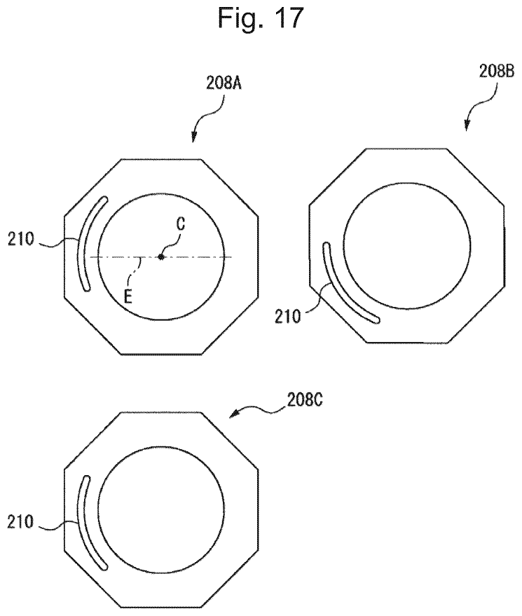

A stator core is configured by stacking a plurality of the core plates 208 in the axial direction. FIG. 17 illustrates a stacking arrangement of the core plate 208. The core plate 208B in FIG. 17 has a shape obtained by rotating the core plate 208A around its central axis C by the center angle θ (=45°) of the octagon. On the other hand, the core plate 208C in FIG. 17 has a shape obtained by inverting the core plate 208A around the symmetry axis E of the octagon by 180°. In a case where the core plate 208B is stacked on the core plate 208A illustrated in FIG. 17, a part of the refrigerant hole 210 of the core plate 208A fluidly communicates with the refrigerant hole 210 of the core plate 208B in the axial direction.

In addition, even in a case where the core plate 208C is stacked on the core plate 208A illustrated in FIG. 17, a part of the refrigerant hole 210 of the core plate 208A fluidly communicates with the refrigerant hole 210 of the core plate 208C in the axial direction. In this manner, by stacking the core plate 208 in the axial direction with the core plate 208 inverted around the symmetry axis E or rotated around the central axis C by the center angle θ, a stator core including a refrigerant channel extending in the circumferential direction and extending stepwise in the axial direction can be produced.

The present disclosure has been described in detail above, but the disclosure is not limited to the embodiments described above. Various additions, replacements, changes, partial deletions, and the like may be made to these embodiments without departing from the gist of the present disclosure or without departing from the gist of the present disclosure derived from the contents described in the claims and equivalents thereof. Further, these embodiments may also be combined and implemented. For example, in the above-described embodiment, the order of the operations and the order of the processes are given as examples, and are not limited thereto. The same applies to the cases where numerical values or mathematical expressions are used in the description of the above-described embodiment.

The present disclosure includes the following aspects.

### (Aspect 1)

A stator core 32, 132 of an electric motor 10, the stator core 32, 132 including: a plurality of core plates 38, 138, 208 stacked in an axial direction of the stator core 32, 132, each core plate 38, 138, 208 having an outer shape of polygon, and including a refrigerant hole 44, 46, 140, 210 of a closed area which defines a channel 62, 162 through which the refrigerant CL flows, in which the plurality of core plates 38, 138, 208 include: a first core plate 38, 138, 208; and a second core plate 38, 138, 210 stacked on the first core plate 38, 138, 208, and having a shape obtained by inverting the first core plate 38, 138, 208 around a symmetry axis E of the polygon or rotating the first core plate 38, 138, 208 around a central axis C of the first core plate 38, 138, 208 by a center angle θ of the polygon; and in which the refrigerant hole 44, 46, 140, 210 of the first core plate 38, 138, 208 extends in a circumferential direction of the stator core 32, 132, and a part of the refrigerant hole 44, 46, 140, 210 of the first core plate 38, 138, 208 fluidly communicates with the refrigerant hole 44, 46, 140, 210 of the second core plate 38, 138, 210 in the axial direction.

### (Aspect 2)

The stator core 32 of Aspect 1, in which the core plate 38 further includes a bolt hole 48a, 48b, 48c, 48d, 48e, 48f, 48g, 48h through which a tie-bolt for fastening the plurality of core plates 38 to each other is inserted, and in which the bolt hole 48a, 48b, 48c, 48d, 48e, 48f, 48g, 48h does not fluidly communicate with the refrigerant hole 44, 46.

### (Aspect 3)

The stator core 32 of Aspect 2, in which the refrigerant hole 44, 46 includes: a first hole part 50 arranged adjacent to the bolt hole 48a, 48e on one side in the circumferential direction; a second hole part 52 arranged adjacent to the bolt hole 48a, 48e on the other side in the circumferential direction; and a third hole part 54 extending in the circumferential direction between the first hole part 50 and the second hole part 52.

### (Aspect 4)

The stator core 32 of Aspect 3, in which the first hole part 50 or the second hole part 52 of the first core plate 38 fluidly communicates with the refrigerant hole 44, 46 of the second core plate 38 in the axial direction, whereas the third hole part 54 of the first core plate 38 does not fluidly communicate with the refrigerant hole 44, 46 of the second core plate 38 in the axial direction.

### (Aspect 5)

The stator core 132 of Aspect 1, in which the refrigerant hole 140 includes: an elongate hole 142, 144 extending in the circumferential direction; and a circular hole 146, 148, 150, 152 arranged separate from the elongate hole 142, 144 in the circumferential direction, in which the elongate hole 142, 144 of the first core plate 138 and the circular hole 146, 148, 150, 152 of the second core plate 138 fluidly communicate with each other in the axial direction, and in which a tie-bolt for fastening the plurality of core plates 138 to each other is inserted into the elongate hole 142, 144 of the first core plate 138 and the circular hole 146, 148, 150, 152 of the second core plate 138.

### (Aspect 6)

A stator 30, 130 of an electric motor 10, the stator 30, 130 including: the stator core 32, 132 of any one of Aspects 1 to 5; and a bracket 34, 36, 134, 136 fixed to an end portion of the stator core 32, 132 in the axial direction, in which the bracket 34, 36, 134, 136 includes: a refrigerant inlet 102, 104, 196 for introducing the refrigerant CL into the channel 62, 162 defined by the refrigerant holes 44, 46, 140, 210 of the plurality of core plates 38, 138, 208; or a refrigerant outlet 114, 116, 198 for ejecting the refrigerant CL flowing through the channel 62, 162 defined by the refrigerant holes 44, 46, 140, 210 of the plurality of core plates 38, 138, 208.

### (Aspect 7)

An electric motor 10 including the stator 30, 130 of Aspect 6.

### (Aspect 8)

A method of manufacturing the stator core 32, 132 of any one of Aspects 1 to 5, the method including: producing the plurality of core plates 38, 138, 208 by press working, using a common die MD1, MD2; picking up one of the plurality of produced core plates 38, 138, 208 and setting the one to a jig JG1, JG3 as the first core plate 38, 138, 208; and picking up another one of the plurality of produced core plates 38, 138, 208, and stacking the another one on the first core plate 38, 138, 208 set to the jig JG1, JG3 as the second core plate 38, 138, 208 after inverting the another one around the symmetry axis E thereof or rotating the another one around the central axis C thereof by the center angle θ, such that the part of the refrigerant hole 44, 46, 140, 210 of the first core plate 38, 138, 208 fluidly communicates with the refrigerant hole 44, 46, 140, 210 of the second core plate 38, 138, 208 in the axial direction.

### REFERENCE SIGNS LIST

10 Electric motor
12 Rotor
30, 130 Stator
32, 132 Stator core
34, 36, 134, 136 Bracket
38, 138, 208 Core plate
44, 46, 140, 210 Refrigerant hole
48, 106, 118 Bolt hole
50, 154 First hole part
52, 156 Second hole part
54, 158 Third hole part
62, 64, 66, 68, 70, 72, 74, 76, 78, 80, 82, 84, 86, 88, 90, 92, 94, 162, 164, 166, 168, 170, 172,
174, 176, 178, 180, 182, 184, 186 Channel
102, 104, 196 Refrigerant inlet
114, 116, 198 Refrigerant outlet
142, 144 Elongate hole
146, 148, 150, 152 Circular hole
n the axial direction.

1. A stator core of an electric motor, the stator core comprising:
a plurality of core plates stacked in an axial direction of the stator core, each core plate having an outer shape of polygon, and including a refrigerant hole of a closed area which defines a channel through which the refrigerant flows,
wherein the plurality of core plates include:
a first core plate; and
a second core plate stacked on the first core plate, and having a shape obtained by inverting the first core plate around a symmetry axis of the polygon or rotating the first core plate around a central axis of the first core plate by a center angle of the polygon; and
wherein the refrigerant hole of the first core plate extends in a circumferential direction of the stator core, and a part of the refrigerant hole of the first core plate fluidly communicates with the refrigerant hole of the second core plate in the axial direction.

2. The stator core of claim 1, wherein the core plate further includes a bolt hole through which a tie-bolt for fastening the plurality of core plates to each other is inserted, wherein the bolt hole does not fluidly communicate with the refrigerant hole.

3. The stator core of claim 2, wherein the refrigerant hole includes:
a first hole part arranged adjacent to the bolt hole on one side in the circumferential direction;
a second hole part arranged adjacent to the bolt hole on the other side in the circumferential direction; and
a third hole part extending in the circumferential direction between the first hole part and the second hole part.

4. The stator core of claim 3, wherein the first hole part or the second hole part of the first core plate fluidly communicates with the refrigerant hole of the second core plate in the axial direction, whereas the third hole part of the first core plate does not fluidly communicate with the refrigerant hole of the second core plate in the axial direction.

5. The stator core of claim 1, wherein the refrigerant hole includes:
an elongate hole extending in the circumferential direction; and
a circular hole arranged separate from the elongate hole in the circumferential direction, wherein the elongate hole of the first core plate and the circular hole of the second core plate fluidly communicate with each other in the axial direction, and
wherein a tie-bolt for fastening the plurality of core plates to each other is inserted into the elongate hole of the first core plate and the circular hole of the second core plate.

6. A stator of an electric motor, the stator comprising:
the stator core of claim 1; and
a bracket fixed to an end portion of the stator core in the axial direction,
wherein the bracket includes:
a refrigerant inlet for introducing the refrigerant into the channel defined by the refrigerant holes of the plurality of core plates; or
a refrigerant outlet for ejecting the refrigerant flowing through the channel defined by the refrigerant holes of the plurality of core plates.

7. An electric motor comprising the stator of claim 6.

8. A method of manufacturing the stator core of claim 1, the method comprising:
producing the plurality of core plates by press working, using a common die;
picking up one of the plurality of produced core plates and setting the one to a jig as the first core plate; and
picking up another one of the plurality of produced core plates, and stacking the another one on the first core plate set to the jig as the second core plate after inverting the another one around the symmetry axis thereof or rotating the another one around the central axis thereof by the center angle, such that the part of the refrigerant hole of the first core plate fluidly communicates with the refrigerant hole of the second core plate in the axial direction.
